(19) United States
(12) Patent Application Publication
(10) Pub. No.: US 2011/0242649 A1
(43) Pub. Date: Oct. 6, 2011

(54) Wavefront measurement method, wavefront measurement apparatus, and microscope

(76) Inventor: Yoshiaki Murayama, Machida-shi (JP)

(21) Appl. No.: 13/065,502

(22) Filed: Mar. 22, 2011

(30) Foreign Application Priority Data
Mar. 31, 2010 (JP) 2010-083476

(51) Int. Cl. G02B 21/06; G01B 11/02

(52) U.S. Cl. 359/389; 356/512

(57) ABSTRACT

A wavefront is measured with superior precision even if the density of scatterers in the vicinity of a focal plane is low. Provided is a wavefront measurement method including a contrast measuring step of measuring the contrast of an interference pattern corresponding to each part of a specimen containing a scatterer, generated by interfering reference light and return light from a focal plane in the specimen; a region extracting step of extracting a high-contrast region in which the contrast measured in the contrast measuring step is greater than or equal to a prescribed threshold; and a wavefront calculating step of converting an interference pattern corresponding to the high-contrast region to wavefront data, for the high-contrast region extracted in the region extracting step.

### BACKGROUND OF THE INVENTION

1. Field of the Invention

The present invention relates to a wavefront measurement method, a wavefront measurement apparatus, and a microscope.

This application is based on Japanese Patent Application No. 2010-083476, the content of which is incorporated herein by reference.

2. Description of Related Art

In a known wavefront measurement method in the related art, the wavefront of return light coming from a focal plane in a specimen containing scatterers is measured by generating an interference pattern using the return light (for example, see US Patent Application No. 2006/0033933).

In this wavefront measurement method, the specimen is divided into a plurality of regions, and the wavefronts obtained from a plurality of interference patterns obtained at a plurality of locations in one region are averaged, thereby measuring the wavefront of the relevant region.

### BRIEF SUMMARY OF THE INVENTION

However, In the method disclosed in US Patent Application No. 2006/0033933, when the number of scatterers in the vicinity of the focal plane in the specimen is small, the intensity of the return light returning from the focal plane is weak, making it impossible to obtained a clear interference pattern, and the measured wavefront values obtained from an indistinct interference pattern show some variations. Thus, the wavefront obtained by averaging measured values showing a large variation differs considerably from the actual values.

A first aspect of the present invention provides a wavefront measurement method including a contrast measuring step of measuring a contrast of an interference pattern corresponding to each part of a specimen containing a scatterer, generated by interfering reference light and return light from a focal plane in the specimen; a region extracting step of extracting a high-contrast region in which the contrast measured in the contrast measuring step is greater than or equal to a prescribed threshold; and a wavefront calculating step of converting an interference pattern corresponding to the high-contrast region to wavefront data, for the high-contrast region extracted in the region extracting step.

The aspect of the present invention described above, may further include a maximum-contrast extracting step of extracting a point where the contrast is maximum in the high-contrast region extracted in the region extracting step, wherein, in the wavefront calculating step, an interference pattern corresponding to the point extracted in the maximum-contrast extracting step may be converted to wavefront data, and the obtained wavefront data may be set as wavefront data for the entire high-contrast region.

The aspect of the present invention described above, may further include an area calculating step of calculating an area of the high-contrast region extracted in the region extracting step; a decision step of determining whether the area calculated in the area calculating step is greater than or equal to a prescribed threshold; a region dividing step of dividing the high-contrast region determined to have an area greater than or equal to the prescribed threshold in the decision step into a plurality of small regions. In the wavefront calculating step, for the small regions formed by division in the region dividing step, an interference patterns corresponding to the small regions may be converted to wavefront data.

In the aspect of the present invention described above, in the contrast measuring step, the contrast of the interference pattern may be measured by subjecting the interference pattern to two-dimensional Fourier transformation.

In the aspect of the present invention described above, in the contrast measuring step, the contrast of the interference pattern may be measured on the basis of a line profile of the interference pattern.

A second aspect of the present invention provides a wavefront measurement apparatus including a contrast measurement section configured to measure a contrast of an interference pattern corresponding to each part of a specimen containing a scatterer, generated by interfering reference light and return light from a focal plane in the specimen; a region extracting section configured to extract a high-contrast region where the contrast measured by the contrast measurement section is greater than or equal to a prescribed threshold; and a wavefront calculating section configured to convert an interference patter corresponding to the high-contrast region into wavefront data, for the high-contrast region extracted by the region extracting section.

A third aspect of the present invention provides a microscope including a splitting portion configured to split light from a light source into illumination light and reference light; an objective lens configured to focus the illumination light split by the splitting portion on a specimen containing a scatterer and to collect return light returning from a focal plane in the specimen; an interference portion configured to generate an interference pattern by interfering the reference light and the return light collected by the objective lens; the wavefront measurement apparatus described above; and a spatial light modulation device configured to modulate the wavefront of light from the light source on the basis of the wavefront data calculated by the wavefront measurement apparatus.

### BRIEF DESCRIPTION OF THE SEVERAL VIEWS OF THE DRAWINGS

FIG. 1 is a diagram showing the overall configuration of a microscope according to an embodiment of the present invention.

FIG. 2 is a block diagram showing a wavefront measurement unit according to an embodiment of the present invention, provided in the microscope shown in FIG. 1.

FIG. 3 is a diagram showing an example of a line profile of an interference pattern used in measuring contrast with a contrast measuring section provided in the wavefront measurement unit in FIG. 2.

FIG. 4 is a flowchart showing a wavefront measurement method according to an embodiment of the present invention, implemented by the microscope shown in FIG. 1.

### DETAILED DESCRIPTION OF THE INVENTION

A wavefront measurement method, wavefront measurement unit (wavefront measurement apparatus), and microscope according to an embodiment of the present invention will be described below with reference to the drawings.

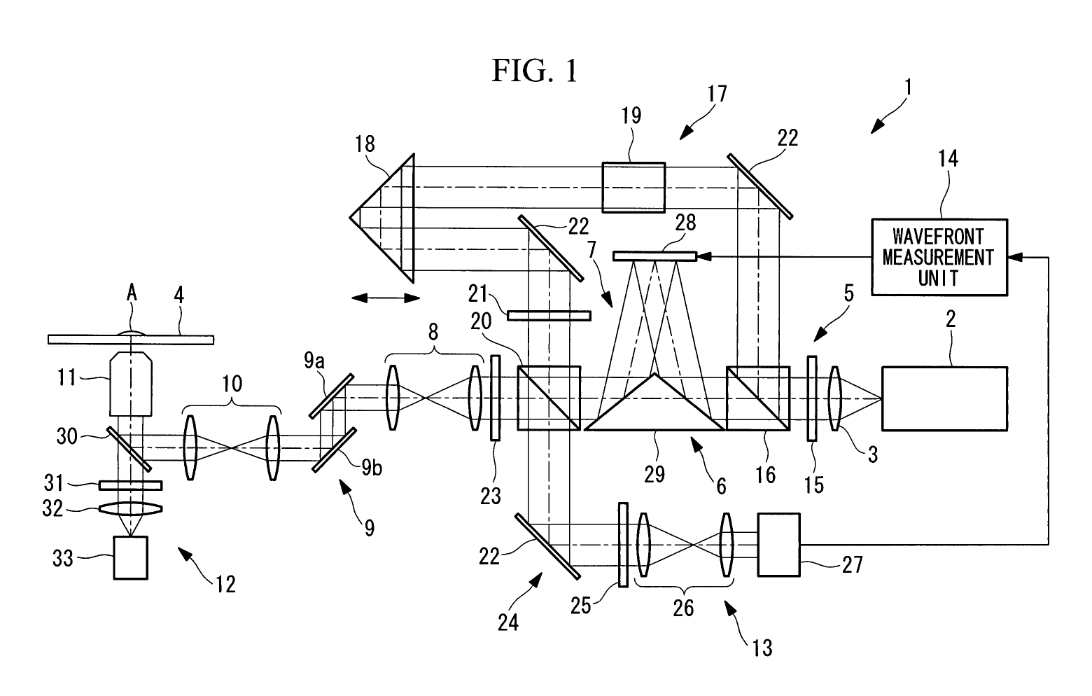

As shown in FIG. 1, a microscope 1 according to the present invention includes a laser light source 2 that generates laser light and a collimator lens 3 that converts the laser light emitted from the laser light source 2 into collimated light.

The microscope 1 includes a stage 4 on which a specimen A placed on a slide glass is mounted and a splitting portion 5 that splits the laser light converted into a collimated light by the collimator lens 3 into illumination light and reference light.

The microscope 1 also includes a wavefront modulating portion 7, which is disposed in an illumination light path 6 along which the illumination light split by the splitting portion 5 travels, for modulating the wavefront of the illumination light; relay lenses 8 and 10; a scanner 9 that scans the laser light; an objective lens 11 that focuses the laser light scanned by the scanner 9 onto the specimen A and that collects return light returning from the specimen A; and a detection portion 12 that detects the return light collected by the objective lens 11.

The microscope 1 also includes an interference portion 13 that causes interference between the reference light and the return light from the specimen A to generate an interference pattern and a wavefront measurement unit (wavefront measurement apparatus) 14 that measures the wavefront of the return light from the generated interference pattern and outputs the wavefront data to the wavefront modulating portion 7.

The splitting portion 5 includes a wave plate 15 that rotates the polarization direction of the laser light converted to a collimated light by the collimator lens 3 by an arbitrary angle and a polarizing light splitter 16 that splits the laser light whose polarization direction is determined upon passing through the wave plate 15 into the reference light and the illumination light.

The wave plate 15 is configured to rotate the polarization direction of the laser light so that the laser light can be split into the reference light and the illumination light with a prescribed light intensity ratio in the polarizing beam splitter 16.

An optical-path-length adjusting prism 18 provided so as to be movable along the optical axis for adjusting the optical path length, a dispersion compensation plate 19 that compensates for group velocity dispersion, and a half-wave plate 21 that rotates the polarization direction of the reference light incident on a polarizing beam splitter 20, described later, by 90° are disposed in a reference light path 17 along which the reference light travels. Reference numerals 22 are mirrors.

The interference portion 13 includes the polarizing beam splitter 20, which is disposed after the wavefront modulating portion 7 provided in the illumination light path 6 along which the illumination light travels and combines the returning illumination light coming from the specimen A and the reference light coming via the reference light path 17; a wave plate 23 that converts the laser light (illumination light) transmitted through the polarizing beam splitter 20 to circularly polarized light, or rotates it by 45°; and a detection light path 24 for detecting the reference light and the return light combined by the polarizing beam splitter 20.

The wave plate 23 is disposed so as to rotate the polarization direction by 90° in the section where the illumination light transmitted through the polarizing beam splitter 20 is focused at the specimen A and then return light from the specimen A re-enters the polarizing beam splitter 20.

A polarizing plate 25 that transmits the return light passing through the wave plate 23 and the reference light passing through the half-wave plate 21 with a prescribed light intensity ratio, respectively; relay lenses 26 that relay the pupil; and an interference-light detector 27 that detects the interference light generated by combining the return light and the reference light are disposed in the detection light path 24.

Since the polarization directions of the return light passing through the wave plate 23 and the reference light passing through the half-wave plate 21 are substantially orthogonal to each other, the polarizing plate 25 has a transmission axis forming an angle greater than 0 relative to the polarization directions of the respective beams. Accordingly, the polarizing plate 25 transmits only components of the return light and the reference light oriented along a prescribed axis.

The interference-light detector 27 is disposed so as to have an optically conjugate positional relationship with the entrance pupil positions of a spatial light modulation device 28, described later, and the objective lens 11.

The wavefront modulating portion 7 includes a prism 29 that reflects the laser light serving as the illumination light and the reflective spatial light modulation device 28, which reflects the laser light reflected by the prism 29, modulates the wavefront of the laser light at that time to a form according to the surface shape thereof, and returns it to the prism 29.

The spatial light modulation device 28 is configured so as to fold the light path so that the laser light reflected by the prism 29 returns to the same prism 29, and returns to the light path on the same axis as the laser light from the laser light source 2.

The spatial light modulation device 28 is configured as a segmented MEMS device whose surface shape can be arbitrarily changed. By inputting wavefront data corresponding to the wavefront measured by the wavefront measurement unit 14, the spatial light modulation device 28 changes the surface shape to a form corresponding to the waveform data and converts the illumination light, which is an incident collimated light, to illumination light having the measured wavefront. The entrance pupil positions of the spatial light modulation device 28 and the objective lens 11 are disposed in an optically conjugate positional relationship.

The scanner 9 is a so-called proximity galvanometer mirror in which two galvanometer mirrors 9a and 9b that can be swiveled about axes disposed in mutually intersecting directions are placed in close proximity, which allows the incident laser light to be scanned two-dimensionally.

The detection portion 12 includes a dichroic mirror 30 that splits off from the illumination light path fluorescence generated in the specimen A by focusing the illumination light thereat with the objective lens 11; a barrier filter 31 that removes illumination light from the fluorescence split off by the dichroic mirror 30; a focusing lens 32 that focuses the fluorescence; and a light detector 33, formed of a photomultiplier tube, for detecting the fluorescence. The objective lens 11 is provided in such a manner that the distance between the objective lens 11 and the stage 4 in the optical axis direction can be adjusted.

By initially setting the surface shape of the spatial light modulation device 28 to a flat reflecting surface, a laser light having a planar wavefront can be made incident at the entrance pupil position of the objective lens 11. Accordingly, the laser light can be focused at the focal plane of the objective lens 11.

By emitting laser light from the laser light source 2 and driving the scanner 9 to two-dimensionally scan the laser light focused at the focal plane in the specimen A while detecting the fluorescence generated at each focal position with the light detector 33, it is possible to obtain a two-dimensional fluorescence image of the specimen A that extends over the focal plane of the objective lens 11.

Furthermore, by acquiring a plurality of two-dimensional fluorescence images (slice images) while varying the position of the focal plane of the objective lens 11 by changing the relative distance between the objective lens 11 and the stage 4, it is possible to obtain a three-dimensional fluorescence image of the specimen A.

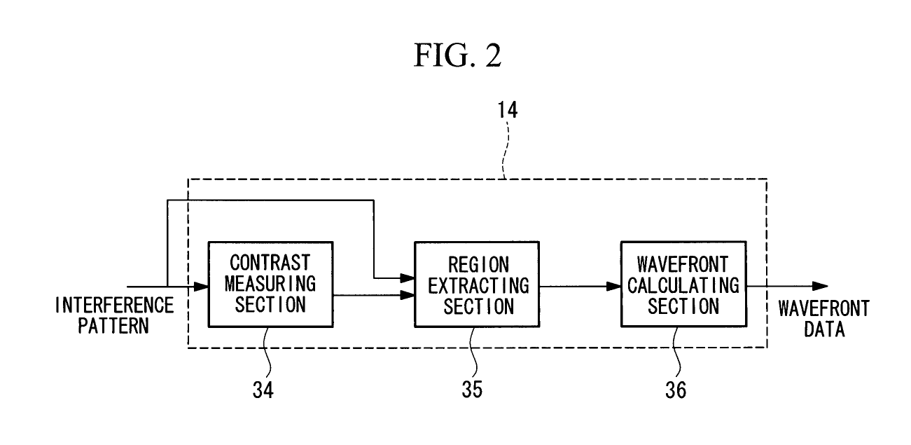

As shown in FIG. 2, the wavefront measurement unit 14 according to this embodiment includes a contrast measurement section 34 that measures the contrast of the interference pattern of the reference light and the return light, detected by the interference-light detector 27; a region extracting section 35 that extracts a high-contrast region in which the contrast measured by the contrast measurement section 34 is equal to or greater than a prescribed threshold; and a wavefront calculating section 36 that converts the interference pattern corresponding to the high-contrast region to wavefront data, in the high-contrast region extracted by the region extracting section 35.

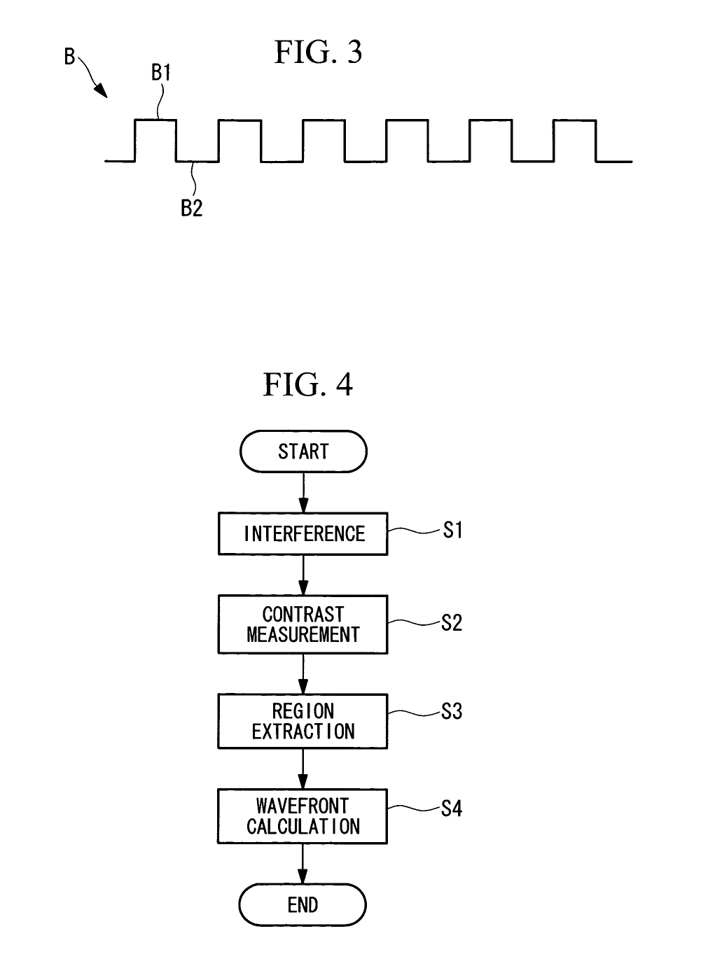

As shown in FIG. 3, the contrast measurement section 34 extracts a line profile B, which is the brightness variation along a prescribed cutting-line in the interference pattern of the reference light and the return light, detected by the interference-light detector 27, and measures the contrast as the difference between the average maximum brightness value B1 and the average minimum brightness value B2 shown in this line profile B.

The wavefront calculating section 36 calculates the wavefront data of the return light coming from a scatterer in the high-contrast region by using only the interference pattern in the high-contrast region extracted by the region extracting section 35. Since the interference pattern in a region other than the high-contrast region, even if one exists, contains a lot of noise, it is not used. Accordingly, the wavefront can be measured with high precision.

A wavefront measurement method and observation method using the microscope 1 according to the thus-configured embodiment will be described below.

Observation of a specimen by using the microscope 1 according to this embodiment is performed by, first, measuring the wavefront of the return light from scatterers present in the focal plane of the objective lens 11, then configuring the spatial light modulation device 28 so that the measured wavefront is generated by the collimated light, and finally introducing the collimated light to the spatial light modulation device 28 and irradiating the specimen A with the illumination light modulated by the spatial light modulation device 28, to thereby obtain a fluorescence image of the specimen A.

As shown in FIG. 4, a wavefront measurement method using the microscope 1 according to this embodiment includes an interference step S1 in which an interference pattern at each part of the specimen A is acquired; a contrast measuring step S2 in which the contrast is measured by the contrast measurement section 34 from the acquired interference patterns; a region extracting step S3 in which a high-contrast region having a measured contrast greater than or equal to a prescribed threshold is extracted by the region extracting section 35; and a wavefront calculating step S4 in which wavefront data is generated by the wavefront calculating section 36 from the interference patterns in the extracted high-contrast regions.

The contrast of the interference pattern corresponding to each part of the specimen is measured in the contrast measuring step, and a high-contrast region having a contrast greater than or equal to a prescribed threshold is extracted in the region extracting step. Then, the wavefront corresponding to each part of the specimen is measured by converting the interference pattern corresponding to the high contrast region to wavefront data in the wavefront calculating step.

In the interference step S1, first the optical path length of the reference light path 17 and the optical path length of the illumination light path 6 are made equal. Optical path length adjustment is carried out by adjusting the position of the optical-path-length adjusting prism 18 to adjust the optical path length of the reference light path 17 between the polarizing beam splitters 16 and 20, thereby precisely matching the optical path length of the illumination light path 6 starting from the polarizing beam splitter 16, turning back at the focal plane of the objective lens 11, and reaching the polarizing beam splitter 20. Then, the spatial light modulator 28 is set to a phase pattern producing a flat reflective surface shape.

In this state, laser light is emitted from the laser light source 2. The laser light emitted from the laser light source 2, having a vertical polarization plane, for example, is transmitted through the wave plate 15, whereupon the polarization direction thereof is rotated by a prescribed angle, and the laser light is incident on the polarizing beam splitter 16. At the polarizing beam splitter 16, the beam is split into two, a vertically polarized component and a horizontally polarized component, one of which, for example, the vertically polarized component, is introduced into the reference light path 17 as reference light, and the other of which is introduced into the illumination light path 6 as illumination light.

The reference light directed to the reference light path 17 is subjected to dispersion compensation upon passing through the dispersion compensating plate 19, and after being reflected back at the optical-path-length adjusting prism 18, the polarization direction thereof is rotated by 90° by the half-wave plate 21 to form a horizontally polarized component. The reference light serving as the horizontally polarized component is transmitted through the polarizing beam splitter 20 and is introduced into the detection light path 24.

On the other hand, the illumination light transmitted through the polarizing beam splitter 16 is introduced into the illumination light path 6 and, after being reflected at the prism 29 and the spatial light modulation device 28, is transmitted through the polarizing beam splitter 20 and passes through the wave plate 23. Accordingly, the illumination light that has been converted to circularly polarized light or had its polarization direction rotated by 45° passes through the relay lenses 8 and is then given an angle by the scanner 9 in order to be directed to a desired focal point. Then, after passing through the relay lenses 10, it is reflected by the dichroic mirror 30 and focused on the specimen A by the objective lens 11.

The returning illumination light reflected at scatterers close to the focal point in the specimen A is collected by the objective lens 11 and is then reflected by the dichroic mirror 30, returns via the relay lenses 10, the scanner 9, and the relay lenses 8, is converted to a vertically polarized component by the wave plate 23, and enters the polarizing beam splitter 20.

The return light with the vertically polarized component entering the polarizing beam splitter 20 is reflected by the polarizing beam splitter 20 and is introduced into the detection light path 24. At this point, the return light with the vertically polarized component is combined with the reference light with the horizontally polarized component coming via the reference light path 17. Then, in the vertically polarized component, that is, the return light from the specimen A, and the horizontally polarized component, that is, the reference light, only the components along the transmission axis of the polarizing plate 25 are transmitted through the polarizing plate 25 and are incident on the interference-light detector 27 via the relay lenses 26. Here, because the polarization directions of the return light and the reference light transmitted through the polarizing plate 25 are the same, the return light and the reference light can be made to interfere with each other. Also, because the optical path length of the reference light path 17 and the optical path length of the illumination light path 6 until the focal plane are set to be the same using the optical-path-length adjusting prism 18, only the return light returning from the focal plane interferes with the reference light.

Accordingly, the difference between the wavefront of the laser light emitted from the laser light source 2 and the wavefront of the laser light which is the return light from the focal plane is detected at the interference-light detector 27 as an interference pattern.

By two-dimensionally scanning the illumination light on the specimen A, it is possible to obtain an interference pattern of the reference light and the return light returning from each part of the entire observation region of the specimen A.

Next, in the contrast measuring step S2, the contrast of the interference pattern for each part of the specimen A obtained in the interference step S1 is measured. The contrast measured in the contrast measuring step S2 is compared with a prescribed threshold in the region extracting step S3, and a high-contrast region having a contrast higher than the prescribed threshold is extracted.

Finally, in the wavefront measuring step S4, the interference pattern for each part of the high-contrast region is converted to wavefront data to be used in the spatial light modulation device 28 when performing observation of the corresponding positions. By inputting the wavefront data to the spatial light modulation device 28, the incident plane-wave illumination light is modulated by the spatial light modulation device 28 to become illumination light having the measured wavefront. When observing each position out of the high-contrast region, the wavefront data input to the spatial light modulation device 28 may be freely set. For example, without modulating the wavefront, wavefront data that enables radiation of plane-wave illumination light may be input to the spatial light modulation device 28, or wavefront data identical to that of the high-contrast region in the vicinity of the observed position may be input to the spatial light modulation device 28.

In other words, with the wavefront measurement unit 14 and the wavefront measurement method according to this embodiment, in an interference pattern obtained by interfering reference light and return light from the focal plane of the specimen A, the wavefront is measured using only the interference pattern in the high-contrast region where the contrast is higher than the prescribed threshold; therefore, measurement of the wavefront with an interference pattern that contains many errors from regions where there are few scatterers is eliminated, which affords an advantage in that it is possible to measure the wavefront with high precision.

That is to say, compared with the conventional measurement method in which an interference pattern generated by return light from a region with a low concentration of scatterers is also used to obtain a wavefront, it is possible to measure a wavefront that is closer to the actual values with superior precision.

Then, in the microscope 1 according to this embodiment, because the wavefront of the illumination light to be made incident on the specimen A when observing each position on the specimen A is adjusted by using the wavefront data measured in this way, it is possible to focus the illumination light at the focal plane of the objective lens 11 with superior precision. Accordingly, it is possible to obtain a clear observation image of the specimen.

If the microscope 1 is a multiphoton-excitation microscope, fluorescence with a sufficiently high photon density is produced at an extremely small focal point in the focal plane, and this fluorescence, which is collected by the objective lens 11, is detected with the light detector 33, thereby affording an advantage in that a fluorescence image with high spatial resolution can be acquired.

In this embodiment, in the high-contrast region, the wavefront of the illumination light to be made incident on the specimen A when observing each position on the specimen A is measured; however, the approach described below may be used instead.

In other words, instead of measuring the wavefront at each position in the high-contrast region, the interference pattern at a position where the contrast is highest in the high-contrast region may be extracted (maximum-contrast extracting step), and the extracted interference pattern may be used to represent the interference pattern of the entire high-contrast region. In this case, in the wavefront calculating step S4, the interference pattern extracted as that corresponding to a point where the contrast is maximum is converted to wavefront data, and the wavefront data obtained is set as the wavefront data for the entire high-contrast region. Also, as for the illumination light to be made incident at an arbitrary position in that high-contrast region, only the wavefront data calculated on the basis of that representative interference pattern is used. By doing so, an advantage is afforded in that it is possible to considerably reduce the amount of calculation required for measuring the wavefront.

Instead of using the representative interference pattern of the position having the maximum contrast, the interference patterns for each position in the high-contrast region may be averaged and used to represent the interference pattern for the entire high-contrast region. Since there are few errors contained in wavefront data based on an interference pattern with high contrast, errors that are present with the conventional approach do not occur, even when using an average value of the interference pattern as the interference pattern for the entire high-contrast region. Thus, by representing the interference pattern for the entire high-contrast region with the average value of the interference pattern, compared with a case where the interference pattern for the position of maximum contrast is used as a representative interference pattern, an advantage is afforded in that it is possible to obtain the proper wavefront data for the whole region, even though the interference pattern is distributed in that region.

If the high-contrast region is large, the interference patterns at each part may differ considerably, in which case, it is not possible to obtain proper wavefront data for the whole region even though the interference patterns for each position in the high-contrast region are averaged. In such a case, it is preferable to calculate the area of the high-contrast region (area calculating step), to determine whether the area is larger than a prescribed size (threshold) (decision step), and if it is larger, to divide the high-contrast region into smaller regions so that the areas are smaller than that size (region dividing step). By doing so, for each small divided region, an interference pattern is acquired in the interference step S1, and after the contrast measuring step S2 and the region extracting step S3, the interference pattern corresponding to each small region is converted to wavefront data in the wavefront calculating step S4.

By doing so, even if the high-contrast region extends over a large area, by generating wavefront data for the small regions formed by dividing the high-contrast region into a plurality of smaller regions, it is possible to precisely measure a wavefront having differing measurement values in the high-contrast region.

In the contrast measuring step S2, the contrast is measured on the basis of a line profile taken along a prescribed cutting-line; instead of this, however, the interference pattern may be subjected to a two-dimensional Fourier transformation, and the contrast may be measured using the amplitude of the brightness obtained for a prescribed wavelength.

Measuring the contrast on the basis of a line profile is advantageous in that the calculation is simplified, and the measurement speed is increased. With a two-dimensional Fourier transformation, because fluctuations or noise in the interference pattern have little influence, an advantage is afforded in that the contrast can be measured with superior precision.

In this embodiment, the spatial light modulation device 28 has been exemplified by a segmented MEMS mirror array whose surface shape can be changed. Instead of this, however, any other spatial light modulation device 28 may be used, for example, a liquid crystal device, a deformable mirror, etc.

What is claimed is:

1. A wavefront measurement method comprising:
a contrast measuring step of measuring a contrast of an interference pattern corresponding to each part of a specimen containing a scatterer, generated by interfering reference light and return light from a focal plane in the specimen;
a region extracting step of extracting a high-contrast region in which the contrast measured in the contrast measuring step is greater than or equal to a prescribed threshold; and
a wavefront calculating step of converting an interference pattern corresponding to the high-contrast region to wavefront data, for the high-contrast region extracted in the region extracting step.

2. A wavefront measurement method according to claim 1, further comprising a maximum-contrast extracting step of extracting a point where the contrast is maximum in the high-contrast region extracted in the region extracting step,
wherein, in the wavefront calculating step, an interference pattern corresponding to the point extracted in the maximum-contrast extracting step is converted to wavefront data, and the obtained wavefront data is set as wavefront data for the entire high-contrast region.

3. A wavefront measurement method according to claim 1, further comprising:
an area calculating step of calculating an area of the high-contrast region extracted in the region extracting step;
a decision step of determining whether the area calculated in the area calculating step is greater than or equal to a prescribed threshold;
a region dividing step of dividing the high-contrast region determined to have an area greater than or equal to the prescribed threshold in the decision step into a plurality of small regions,
wherein, in the wavefront calculating step, for the small regions formed by division in the region dividing step, an interference patterns corresponding to the small regions are converted to wavefront data.

4. A wavefront measurement method according to claim 1, wherein, in the contrast measuring step, the contrast of the interference pattern is measured by subjecting the interference pattern to two-dimensional Fourier transformation.

5. A wavefront measurement method according to claim 1, wherein, in the contrast measuring step, the contrast of the interference pattern is measured on the basis of a line profile of the interference pattern.

6. A wavefront measurement apparatus comprising:
a contrast measurement section configured to measure a contrast of an interference pattern corresponding to each part of a specimen containing a scatterer, generated by interfering reference light and return light from a focal plane in the specimen;
a region extracting section configured to extract a high-contrast region where the contrast measured by the contrast measurement section is greater than or equal to a prescribed threshold; and
a wavefront calculating section configured to convert an interference patter corresponding to the high-contrast region into wavefront data, for the high-contrast region extracted by the region extracting section.

7. A microscope comprising:
a splitting portion configured to split light from a light source into illumination light and reference light;
an objective lens configured to focus the illumination light split by the splitting portion on a specimen containing a scatterer and to collect return light returning from a focal plane in the specimen;
an interference portion configured to generate an interference pattern by interfering the reference light and the return light collected by the objective lens;
a wavefront measurement apparatus according to claim 6; and
a spatial light modulation device configured to modulate a wavefront of light from the light source on the basis of the wavefront data calculated by the wavefront measurement apparatus.
